(19) United States
(12) Patent Application Publication
(10) Pub. No.: US 2024/0427323 A1
(43) Pub. Date: Dec. 26, 2024

(54) APPARATUSES, COMPUTER-IMPLEMENTED METHODS, AND COMPUTER PROGRAM PRODUCTS FOR AUTOMATICALLY SEGREGATING SERVICE CASE RECOMMENDATIONS FOR ASSET MAINTENANCE

(71) Applicant: Honeywell International Inc., Charlotte, NC (US)

(72) Inventors: Srikanth VELAGA, Hyderabad (IN); Sneha NAYAK, Bangalore (IN); Shambhavi JOSHI, Margao (IN); Senthil Nathan C, Tamil Nadu (IN); Karthika MURUGESAN, Mumbai (IN); Jayalaxmi Vaman TELANG, Bangalore (IN); Jaikiran LENKARAM, Bangalore (IN); Dharmendran CHANDRASEKAR, Madurai (IN); Cicily Preethy N J, Kadugodi (IN)

(21) Appl. No.: 18/338,681

(22) Filed: Jun. 21, 2023

(51) Int. Cl. G05B 23/02; G06F 40/40

(52) U.S. Cl. CPC G05B 23/0283; G05B 23/0227; G06F 40/40

(57) ABSTRACT

Embodiments of the present disclosure provide for improved determination of maintenance actions to be performed for a particular asset. Embodiments automatically segment maintenance suggestions into a remotely performable classification and a non-remotely performable classification, and/or enabling initiation of such maintenance actions accordingly. Some embodiments receiving at least one service case recommendation associated with an asset, applying the at least one service case recommendation to an intelligence machine learning model, the intelligence machine learning model configured to determine a data value indicating a likelihood that each service case recommendation of the at least one service case recommendation is remotely performable, determining, via the data value, at least one remotely performable maintenance suggestion from the at least one service case recommendation, and outputting at least one notification associated with the at least one remotely performable maintenance suggestion to a user associated with remote access of the asset.

### TECHNICAL FIELD

Embodiments of the present disclosure generally relate to initiating maintenance of one or more assets, and specifically to automatically segregating options for maintenance of a particular asset based on whether a particular maintenance suggestion is remotely performable.

### BACKGROUND

Over time, an asset within an industrial plant or system may experience one or more issues, malfunctions, or other problems affecting performance of the asset. When initiating maintenance of the asset, any number of options may be available for what actions are performable.

Applicant has discovered problems with current implementations of determining maintenance actions to initiate for a particular asset. Through applied effort, ingenuity, and innovation, Applicant has solved many of these identified problems by developing embodied in the present disclosure, which are described in detail below.

### BRIEF SUMMARY

In one aspect, a computer-implemented method includes receiving at least one service case recommendation associated with an asset, applying the at least one service case recommendation to an intelligence machine learning model, where the intelligence machine learning model is configured to determine a data value indicating a likelihood that each service case recommendation of the at least one service case recommendation is remotely performable, determining, via the data value output via the intelligence machine learning model for the at least one service case recommendation, at least one remotely performable maintenance suggestion from the at least one service case recommendation, and outputting at least one notification associated with the at least one remotely performable maintenance suggestion to a user associated with remote access of the asset.

The computer-implemented method may also further includes determining, via the data value output via the intelligence machine learning model for the at least one service case recommendation, at least one non-remotely performable maintenance suggestion, and outputting at least one additional notification associated with the non-remotely performable maintenance suggestion to the user.

The computer-implemented method may also further include outputting at least one additional notification associated with a non-remotely performable maintenance suggestion to a second user associated with performing a non-remotely performable maintenance action of the asset.

The computer-implemented method may also include where the at least one service case recommendation are determined based at least in part on an alert generation rule for the asset.

The computer-implemented method may also further include automatically initiating a remotely performable maintenance action associated with the remotely performable maintenance suggestion.

The computer-implemented method may also further include updating the intelligence machine learning model based at least in part on user review data indicating whether a particular service case recommendation of the at least one service case recommendation is accurately characterized as remotely performable or not remotely performable.

The computer-implemented method may also include where the intelligence machine learning model determines an initial data value indicating the likelihood that a service case recommendation is remotely performable based at least in part natural language processing of the service case recommendation.

The computer-implemented method may also further include determining at least a first service case recommendation of the at least one service case recommendation is always remotely performable.

The computer-implemented method may also further include determining at least a first service case recommendation of the at least one service case recommendation is always not remotely performable.

The computer-implemented method may also further include applying user configuration data to the intelligence machine learning model, where the intelligence machine learning model is configured to determine the data value indicating the likelihood that each service case recommendation of the at least one service case recommendation is remotely performable based at least in part on the user configuration data.

The computer-implemented method may also include where determining at least the first service case recommendation of the at least one service case recommendation is always remotely performable includes processing text data associated with the at least the first service case recommendation utilizing at least one natural language processing model.

The computer-implemented method may also include where determining at least the first service case recommendation of the at least one service case recommendation is not always performable includes processing text data associated with the first service case recommendation utilizing at least one natural language processing model.

In another aspect, an apparatus is provided. The apparatus includes at least one processor and at least one non-transitory memory having computer-coded instructions stored thereon that, in execution with the at least one processor causes the apparatus to perform any one of the example computer-implemented methods described herein.

In another aspect, a computer program product is provided. The computer program product includes at least one non-transitory computer-readable storage medium having computer program code stored thereon that, in execution with at least one processor, configures the computer program product to perform any one of the example computer-implemented methods described herein.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example system within which embodiments of the present disclosure may operate.

FIG. 2 illustrates a schematic diagram of an example apparatus in accordance with at least one embodiment of the present disclosure.

FIG. 3 illustrates an example data flow for generation of one or more asset alerts based on asset operation in accordance with at least one embodiment of the present disclosure.

FIG. 4 illustrates a representation of a link between an alert generation rule and at least one service case recommendation corresponding to the alert generation rule accordance with at least one embodiment of the present disclosure.

FIG. 5 illustrates a representation of weightings associated with whether a service case recommendation is remotely performable in accordance with at least one embodiment of the present disclosure.

FIG. 6 illustrates an example data flow for automatically segregating maintenance suggestions in accordance with at least one embodiment of the present disclosure.

FIG. 7 illustrates an example data flow for updating determination of remotely performable maintenance suggestions based at least in part on user review data in accordance with at least one embodiment of the present disclosure.

FIG. 8 illustrates a flowchart depicting example operations of an example process in accordance with at least one embodiment of the present disclosure.

### OVERVIEW

In various contexts, one or more assets interact to perform an industrial process. For example, one or more assets of an industrial plant may include any number of robots, machinery, computing devices, and/or the like that manipulates physical ingredients, data, and/or the like. In some such contexts, the assets may be monitored by one or more sensors, systems, and/or the like. For example, in various circumstances, a central monitoring system may track key performance metrics associated with operation of one or more assets based on sensor data, analog detected data, and/or digital data representing such operational aspects of the one or more assets. In this regard, assets may be monitored to determine how a particular asset, or group of assets, is performing, and/or whether the particular asset is functioning as desired or intended.

Often, performance of an asset degrades over time for any of a myriad of reasons. To avoid significant performance decreases in the performance of the asset, or even a catastrophic failure completely preventing operation of the asset, maintenance may be performed on a particular asset. Performance of maintenance itself, however, causes multiple problems for the operator of such assets and/or associated industrial process to which that asset contributes. For example, in various circumstances maintenance of an asset requires that the asset be non-functional, or at least partially non-functional (e.g., operating in a degraded state) for a particular period of time during which maintenance occurs. Additionally or alternatively, maintenance of a particular asset often requires resource expenditure by the operator and/or owner of the asset, for example by assigning human resources to perform the maintenance, incurring costs for replacement components of the asset to utilize during maintenance, and/or the like. In this regard, balancing the positive aspects of performing maintenance on an asset with the corresponding negative aspects of performing such maintenance on the asset is appropriate to avoid performing maintenance at the expense of ongoing operations and resources when such maintenance does not provide a sufficient benefit to performance of the asset.

One manner in which assets are maintained is via performance of remote actions. For example, remotely performable actions may enable a user (e.g., an administrator of the asset and/or a maintenance worker) to initiate a particular action that reconfigures an asset. In this regard, such remotely performable maintenance suggestions may provide for any number of remotely performable maintenance actions, each remotely performable maintenance action indicating a step, resolution of an identified problem, and/or the like that is indicated to affect performance of the asset. Non-limiting examples of such maintenance actions include connecting to a remote computing device of or associated with an asset and altering particular configurations of the asset, updating software and/or firmware installed to or utilized by the asset, installing new software and/or firmware to the asset, and/or the like. Alternatively or additionally, in some circumstances a maintenance action may be performed that requires a user to physically reach the asset and/or interact with the asset (e.g., to replace a component of the asset, fix a particular component or subsystem of the asset, and/or the like). In this regard, a maintenance technician or other use may be dispatched to the asset to perform such maintenance actions in the real world rather than in digital space.

In such contexts, performance of remotely performable maintenance actions is often preferred. Particularly, maintenance actions that are not remotely performable generally cause an asset to be offline or otherwise unavailable for a greater period of time to enable the maintenance to be performed. Additionally, such maintenance actions that are not remotely performable are generally more costly to perform, as an entity in control of such assets must incur the cost of human resources (e.g., an individual maintenance technician for example, or multiple maintenance technicians) reaching the physical location of the asset, interacting with the asset, and interacting with the various components of the asset. Such non-remotely performable maintenance actions additionally or alternatively increase the risk of human maintenance error affecting the operation of the asset, or in a worse scenario affecting an industrial process as a whole. For these reasons, remotely performable maintenance is generally more efficient, less time consuming, less resource intensive, and generally preferred if such maintenance actions may result in a resolution to an identified problem represented by a service case or alert.

Often, however, multiple maintenance actions corresponding to service case recommendations may be available for performance. Such service case recommendations may, for a given problem represented by an alert raised via a particular alert generation rule, represent a knowledge base or other set of determined solutions corresponding to each alert raised for the particular alert generation rule. Additionally or alternatively, a system and/or user often cannot readily determine which service case recommendations are remotely performable, if any. In this regard, systems that recommend particular actions to be taken in response to determined maintenance needs often do not, and indeed cannot, accurately consider whether such maintenance actions (e.g., represented by maintenance suggestions) are remotely performable. Such systems therefore may often result in inaccurate or undesirable suggestions in a circumstance where it is desirable to perform one or more remotely performable maintenance suggestions before suggesting alternative maintenance actions.

Embodiments of the present disclosure automatically segregating service case recommendations for asset maintenance as remotely performable or non-remotely performable. Additionally or alternatively, embodiments of the present disclosure automatically provide remotely performable maintenance suggestions, or in general particular determined maintenance suggestions, for performing asset maintenance corresponding to particularly triggered alert generation rules. Some such embodiments may accurately determine and provide remotely performable maintenance suggestions where appropriate, and/or automatically facilitate improved accuracy in determinations of whether a particular service case recommendation is remotely performable over time as such embodiments operate based on user review data associated with previously outputted maintenance suggestions.

Some embodiments utilize an intelligence machine learning model that is specially trained to automatically segregate service case recommendations into remotely performable and non-remotely performable such that remotely performable maintenance suggestions may be made. The intelligence machine learning model is specially trained based at least in part on particular data made available to the intelligence machine learning model. For example, in some embodiments, the natural language processing model takes as input a set of service case recommendations corresponding to a particular triggered alert generation rule. The alert generation rule may be triggered automatically in response to a data-driven determination based at least in part on operational data associated with operation of an asset itself. Additionally or alternatively, in some embodiments the intelligence machine learning model takes as input user configuration data indicating previously performed user interactions corresponding to particular service case recommendations, where such user interactions indicate at least in part whether a service case recommendation is remotely performable. In some embodiments, the natural language processing model is configured to learn from training data during a training phase, for example where the training data similarly includes service case recommendations, user configuration data, associated labels indicating whether a service case recommendation was remotely performable or non-remotely performable, and/or the like. Additionally or alternatively, in some embodiments, the natural language processing model learns based at least in part on user review data received from a user in response to particular determined and outputted remotely performable maintenance suggestions, for example where the user review data indicates whether such outputted remotely performable maintenance actions are actually remotely performable.

In some embodiments, the natural language processing model is utilized to update a weighting associated with a particular service case recommendation, for example where the weighting indicates how likely the service case recommendation is to be remotely performable. In some such embodiments, once the weighting satisfies (e.g., exceeds) a particular threshold, the service case recommendation may be determined remotely performable. Additionally or alternatively, in some embodiments, once the weighting satisfies (e.g., falls below) a particular threshold, the recommendation may be determined non-remotely performable. In this regard, the natural language processing model learns to automatically segment service case recommendations into remotely performable and non-remotely performable with improved accuracy, and such accuracy in some embodiments improves over subsequent iterations.

Additionally or alternatively, some embodiments perform, automatically trigger, or otherwise automatically initiate particular processes based on determined, outputted, and/or selected maintenance suggestions. For example, some embodiments automatically initiate at least a portion of a remotely performable maintenance suggestion, such as by initiating a remotely performable maintenance action automatically or upon confirmation of a user without the user having to perform the maintenance action explicitly. Additionally or alternatively, some embodiments simply provide remotely performable maintenance suggestions to a user, for example via a user interface, to enable the user to identify and quickly initiate one or more of such remotely performable maintenance suggestions without initiating a more resource intensive, error prone, and/or time restrictive non-remotely performable maintenance suggestion. Additionally or alternatively still, in a circumstance where no remotely performable maintenance suggestion is identified, some embodiments may automatically generate and/or transmit message(s), user interface(s), and/or the like that prompt or initiate performance of one or more non-remotely performable maintenance actions associated with an outputted non-remotely performable maintenance suggestion.

Embodiments of the present disclosure provide for a myriad of technical advantages. By automatically segregating service case recommendations, embodiments of the present disclosure advantageously more accurately determine which maintenance suggestions may be output and are remotely performable. In this regard, embodiments of the present disclosure enable provision of improved maintenance insights to users based on such improved and automatic segregation of service case recommendations into remotely performable or non-remotely performable. Additionally or alternatively, by more accurately identifying remotely performable maintenance suggestions for outputting, embodiments of the present disclosure reduce resource expenditure, maintenance downtime, and/or risk of maintenance errors conventionally caused by non-remotely performable maintenance actions that require physical interaction with an asset.

### Definitions

“Alert generation rule” refers to one or more defined data-driven comparisons, determinations, and/or other triggers that indicate problematic, non-typical, or other malfunctioning operation of an asset based on operational data associated with that asset.

“Asset” refers to any machine, robot, computing device, and/or industrial control system that contributes to an industrial process.

“Asset alert” refers to electronically managed data generated in response to an alert generation rule based on operational data associated with operation of an asset.

“Intelligence machine learning model” refers to a machine learning model specially trained to learn to distinguish classification of a service case recommendation into a classification of remotely performable or non-remotely performable.

“Maintenance action” refers to any particular activity that affects operation an asset by reconfiguring, replacing, or otherwise altering at least one aspect of the asset or the asset itself. “Non-remotely performable maintenance action” refers to performance of a maintenance action of an asset by physically interacting with, replacing, or otherwise engaging the asset in a physical environment. “Remotely performable maintenance action” refers to performance of a maintenance action of an asset by digitally interacting with, replacing, or otherwise engaging the asset via a digital environment.

“Maintenance suggestion” refers to a service case recommendation selected or otherwise outputted via an intelligence machine learning model associated with a particular asset or group of assets. “Remote maintenance suggestion” refers to a maintenance suggestion that is determined to be remotely performable. “Non-remotely performable maintenance suggestion” refers to a maintenance suggestion determined to be non-remotely performable in whole or at least in part.

“Natural language format” refers to electronically managed text data that is presented in a contextual domain understandable to one or more human users.

“Natural language processing model” refers to a specially trained model that generates text data in a natural language format and/or processes text data in a natural language format.

“Notification” refers to any audio, visual, other digital, and/or physical output that indicates one or more maintenance suggestions via one or more computing devices. Non-limiting examples of a notification include a push notification, a text message, an email notification, an audio output, a light display, and a user interface of an application outputted via a user device accessible to a particular user.

“Operational data” refers to electronically managed data indicating a status of operation of a particular monitored aspect of an asset during operation of the asset.

“Remote access” refers to any authorized digital access, command, and/or engagement of an asset.

“Remotely performable” with respect to maintenance refers to a maintenance action for reconfiguring or otherwise altering operation of an asset that is

“Remotely performable maintenance suggestion” refers to a service case recommendation determined to be remotely performable.

“Service case recommendation” refers to a determined set of one or more maintenance actions that are indicated as options for maintaining an asset in response to triggering of one or more alert generation rules. In some contexts a service case recommendation is linked to a particular alert generation rule in a manner that the service case recommendation is retrievable utilizing data identifying the alert generation rule to which it is linked.

“User” refers to any entity that interacts with representations of or user interfaces associated with maintenance suggestions outputted via an intelligence machine learning model to initiate, schedule, or perform one or more maintenance actions. In some contexts a user is an owner, possessor, or other person engaging a computing device that receives outputs or representations, for example via a user interface, of one or more maintenance suggestions associated with an asset to enable the user to initiate a remotely performable maintenance action corresponding to a remotely performable maintenance suggestion.

“User configuration data” refers to electronically managed data representing whether user-initiated actions indicate a corresponding service case recommendation is remotely performable.

“User review data” refers to user-inputted data indicating whether a maintenance suggestion outputted by an intelligence machine learning model is remotely performable.

“Weighting” refers to electronically managed data assigned to a particular service case recommendation that that indicates a determined likelihood that the particular service case recommendation is remotely performable.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Example Systems and Apparatuses of the Disclosure

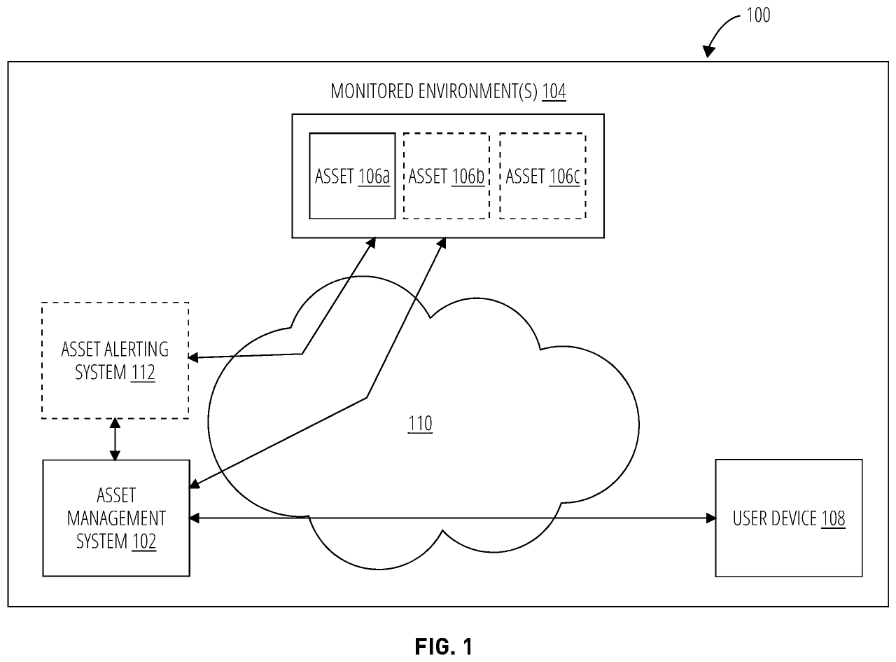

FIG. 1 illustrates a block diagram of a system in which embodiments of the present disclosure may operate. Specifically. FIG. 1 depicts an example system 100. As illustrated, the system 100 includes an asset management system 102, one or more asset 106a-106c located in a monitored environment(s) 104, and user device 108. The system 100 optionally includes a separate asset alerting system 112. Alternatively or additionally, in some embodiments, the asset management system 102 embodies or includes some or all of the asset alerting system 112, such that the asset management system 102 and asset alerting system 112 embody a single computing device or system. In some embodiments, the system 100 includes at least one communications network 110. The communications network 110 enables communication between the asset management system 102, one or more of the assets embodied by asset 106a-106c, and/or user device 108. Additionally or alternatively, in some embodiments, the communications network 110 communicatively couples the asset alerting system 112 with the asset management system 102.

It should be appreciated that the communications network 110 in some embodiments is embodied in any of a myriad of network configurations. In some embodiments, the communications network 110 embodies a public network (e.g., the Internet). In some embodiments, the communications network 110 embodies a private network (e.g., an internal localized, or closed-off network between particular devices). In some other embodiments, the communications network 110 embodies a hybrid network (e.g., a network enabling internal communications between particular connected devices and external communications with other devices). The communications network 110 in some embodiments includes one or more base station(s), relay(s), router(s), switch(es), cell tower(s), communications cable(s) and/or associated routing station(s), and/or the like. In some embodiments, the communications network 110 includes one or more user-controlled computing device(s) (e.g., a user owned router and/or modem) and/or one or more external utility devices (e.g., Internet service provider communication tower(s) and/or other device(s)).

Each of the components of the system 100 communicatively coupled to transmit data to and/or receive data from one another over the same or different wireless and/or wired networks embodying the communications network 110. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 110, the various embodiments are not limited to this architecture. Additionally or alternatively, one or more other devices may perform the communication associated with a particular computing device. For example, in some embodiments, an asset is associated with one or more sensors, where the sensors communicate data (e.g., operational data) associated with the asset to the asset management system 102. In other embodiments, one or more computing entities share one or more components, hardware, and/or the like, or otherwise are embodied by a single computing device such that connection(s) between the computing entities are over the communications network 110 are altered and/or rendered unnecessary.

In some embodiments, the asset management system 102 is/are embodied in an on-premises system within or associated with a particular monitored environment. For example, in some embodiments the asset management system 102 is a local system within the monitored environment(s) 104 associated with the one or more assets 106a-106c. In some embodiments, the on-premises system embodied by the monitored environment(s) 104 is communicatively coupled to one or more of the assets 106a-106c via at least one wired device. Additionally or alternatively, one or more of such systems may be remote from one another, for example where the assets 106a-106c are within one or more monitored environment(s) 104 being monitored by sensors of or associated with the assets 106a-106c, and where the asset management system 102 is a cloud system or otherwise remotely located from the monitored environment(s) 104.

An asset, for example one or more of the assets 106a-106c includes any number of computing device(s), system(s), robot(s), machinery, and/or the like, that contribute towards at least a portion of a particular industrial process. For example, in some embodiments, the assets 106a-106c define individual processing units that each perform a sub-step of the industrial process. In one example context, the assets 106a-106c embody physical components embodying processing units, tanks, valves, pipes, and/or control systems, of an oil refinery that processes crude oil and/or other input products to produce a particular desired target product. In another context, the assets 106a-106c represent systems of a building, for example HVAC units, security systems, utility systems, subcomponents thereof, and/or the like. In another context, the assets 106a-106c embody components of a chemical plant, manufacturing facility, building, and/or the like that performs one or more process(es) via the assets 106a-106c that are monitorable via data capture, as described herein. Non-limiting examples of an asset, for example one of the assets 106a-106c includes a hydrocracker, a blender, a storage tank, a visbreaker, and the like (e.g., in an oil refining context), a security system, HVAC unit, gas utility system, electric utility system, and water utility system (e.g., in a building management context), and/or the like. It should be appreciated that a particular monitored environment may include any number of assets, where operational data is detectable, trackable, and/or otherwise determined based on the operation of the asset.

In some embodiments, an asset embodies or includes at least one sensor. Each sensor monitors at least one operational aspect of the asset. In this regard, as the asset operates, the sensor may determine, detect, measure, and/or otherwise capture data value(s) indicating a at least a portion of operational data associated with the operation of the asset. In this regard, the operational data may include data values for particular performance metrics tracked for a particular asset. Non-limiting of such performance metrics includes operation speed of one or more component(s), average time to complete a task, and/or the like. In some embodiments, each sensor is embodied in hardware, software, firmware, and/or a combination thereof that detects or otherwise determines the data value for a particular performance metric associated with operation of the asset. For example, in some embodiments an asset includes an internal heat sensor, operational speed monitor for a particular component of the asset, and/or the like that is housed within or otherwise communicatively coupled to the asset itself during operation. In some other embodiments, an asset is associated with an external and/or otherwise separate sensor embodied in hardware, software, firmware, and/or a combination thereof, that detects or otherwise determines the data value for a particular performance metric associated with operation of the asset. For example, in some embodiments a camera, temperature gauge, pressure sensor, or other sensor monitors the output or environment surrounding at least one component of the asset to determine the particular performance metric during operation of that asset.

The asset management system 102 includes any number of computing device(s), system(s) embodied in hardware, software, and/or the like that performs operations for automatically segmenting service case recommendations, for example into classifications of remotely performable and non-remotely performable classifications. Additionally or alternatively, in some embodiments the asset management system 102 includes any number of computing device(s), system(s) embodied in hardware, software, firmware, and/or the like that performs operations for one or more processes based on the segmentation of service case recommendations. Additionally or alternatively, in some embodiments, the asset management system 102 includes one or more displays, peripherals, client devices, user devices, and/or the like, that enables access to functionality provided via the asset management system 102, for example via a web application, native application, and/or the like. In some embodiments, such functionality is handled by an external user device or other computing device, for example a user device 108.

In some embodiments, the asset management system 102 is specially configured to perform segmentation of service case recommendations for at least one asset. For example as illustrated, in some embodiments the asset management system 102 monitors for service case recommendation and segments such service case recommendations for at least the asset 106a. In this regard, the asset management system 102 may segment service case recommendations corresponding to particular alerts triggered based at least in part on the operations of the asset itself. Such determinations may be performed utilizing data-driven determinations based at least in part on data representing or derivable from actual performance of the asset, for example operational data and/or associated performance metrics. In some embodiments, the asset management system 102 identifies service case recommendations, and/or segments such service case recommendations, based on a combination of some or all of the assets 106a-106c. In this regard, identified service case recommendations segmented in accordance with the present disclosure may include service case recommendations triggered based solely on a single asset, for example asset 106a, or a combination of assets, for example the combination of assets 106a-106c. As described herein, in some embodiments the asset management system 102 includes, maintains, or otherwise accesses an intelligence machine learning model specially configured to perform segmentation of one or more service case recommendations as described herein.

The optional asset alerting system 112 includes any number of computing device(s), system(s) embodied in hardware, software, and/or the like that performs monitoring of operations at least one particular asset, as described herein. In some embodiments, an asset alerting system 112 includes one or more specially configured application server(s), database server(s), end user device(s), cloud computing system(s), and/or the like. Additionally or alternatively, in some embodiments, the asset alerting system 112 includes one or more displays, peripherals, client devices, user devices, and/or the like, that enables access to functionality provided via the asset alerting system 112, for example via a web application, native application, and/or the like. In some embodiments, such functionality is handled by an external user device or other computing device, for example a user device 108. Additionally or alternatively, in some embodiments such functionality for outputting to a user is handled via another system communicable with the asset alerting system 112, such as the asset management system 102. Additionally or alternatively, in some embodiments, the asset alerting system 112 is embodied by the asset management system 102, or as a subsystem of the asset management system 102

In some embodiments, the asset alerting system 112 is specially configured to perform asset operations monitoring and/or alerting for at least one asset. For example, as illustrated, in some embodiments the asset alerting system 112 performs asset monitoring for at least asset 106a. In this regard, the asset alerting system 112 may receive operational data associated with the asset 106a as the asset 106a operates, for example from the asset 106a itself or a sensor associated with the asset 106a. Additionally or alternatively, in some embodiments, the asset alerting system 112 generates and/or derives one or more performance metrics associated with the asset 106a based at least in part on the operational data. In some embodiments, the asset alerting system 112 includes or embodies one or more database(s) that store the operational data and/or performance metrics associated with the asset 106a.

In some embodiments, the asset alerting system 112 is specially configured to generate and/or trigger one or asset alerts based at least in part on monitored operation of the asset 106a. For example, in some embodiments, the asset alerting system 112 maintains at least one alert generation rule defining data-driven determinations, checks, and/or other processes that, when satisfied, trigger generation of an asset alert. In one example context, an alert generation rule includes particular equations or other processes based on data values represented in or derived from the operational data that indicate poor performance of the asset, malfunctioning of a particular subcomponent of the asset, and/or the like. In some embodiments, each generated asset alert is stored via the asset alerting system 112, for example such that the asset alerting system 112 generates and/or stores alert history data for a particular asset or plurality of assets. Additionally or alternatively, in some embodiments the asset alerting system 112 outputs the generated asset alert, or a notification associated therewith, to the asset management system 102, and/or an associated user device, such as user device 108, for further processing. Additionally or alternatively still, in some embodiments, the asset alerting system 112 maintains data embodying service case recommendations corresponding to a particular alert generation rule and/or asset alert generated based on a particular alert generation rule.

It should be appreciated that while the above is described with respect to monitoring the asset 106a, a plurality of assets may be similarly monitored. For example, in some embodiments, the asset alerting system 112 individually monitors each of the asset 106a, asset 106b, and asset 106c. Alternatively or additionally, in some embodiments, the asset alerting system 112 monitors collective data associated with the assets 106a-106c as a group.

The user device 108 includes any number of computing device(s), system(s) embodied in hardware, software, and/or the like that perform outputting of data associated with segmentation of service case recommendations, and/or a particular portion thereof, to a user. In some embodiments, the user is a maintenance worker or other entity responsible for performing maintenance actions associated with a particular asset. The maintainer in some embodiments is a remote maintenance worker that has digital access to at least one asset, such as the asset 106a. In some embodiments, a user device 108 includes one or more smartphones, tablets, laptops, personal computers, and/or other end-user devices. The user device 108 may be specially configured via particular software applications, including individual “apps” for example, which initiate the particular functionality as depicted and described herein. Additionally or alternatively, in some embodiments, the user device 108 includes another application server, intermediary computing device, and/or the like that routes output to a particular end user. In some embodiments, the user device 108 includes at least one display that facilitates output to an end user.

In some embodiments, the user device 108 is specially configured to perform output of notifications and/or other data associated with segmentation of service case recommendation. In some embodiments, user device 108 outputs one or more notifications associated with remotely performable maintenance suggestions to be performed by the user of the user device 108, for example where the user of the user device 108 is a remote maintenance worker having digital access to the asset. Additionally or alternatively, in some embodiments, the user device 108 outputs one or more notifications associated with non-remotely performable maintenance suggestions to be performed by the user of the user device 108, for example where the user of the user device 108 is a maintenance worker having physical access to the asset. Additionally or alternatively, in some embodiments, the user device 108 provides access to functionality for configuring one or more parameters associated with automatic segregation of service case recommendations into remotely performable maintenance suggestions and/or non-remotely performable maintenance suggestions. For example, in some embodiments the user device 108 executes or accesses one or more software applications that provide functionality to adjust one or more weightings associated with a particular service case recommendation, set one or more thresholds (e.g., a threshold that if satisfied indicates that the service case recommendation is always remotely performable, and/or a threshold that if satisfied indicates that the service case recommendation is always not remotely performable), and/or input user review data corresponding to at least one outputted maintenance suggestion (e.g., a remotely performable maintenance suggestion).

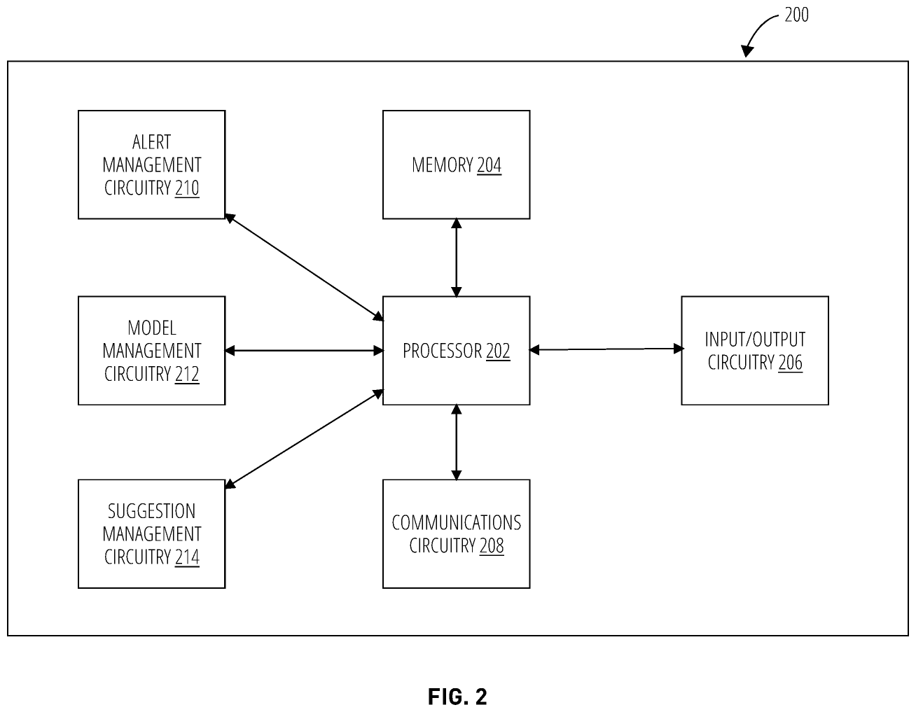

FIG. 2 illustrates a schematic diagram of an apparatus in accordance with at least one embodiment of the present disclosure. Specifically, FIG. 2 depicts an example asset management apparatus 200 (“apparatus 200”) specially configured in accordance with at least some example embodiments of the present disclosure. In some embodiments, the asset management system 102 and/or a portion thereof is embodied by one or more system(s), such as the apparatus 200 as depicted and described in FIG. 2. The apparatus 200 includes processor 202, memory 204, input/output circuitry 206, communications circuitry 208, alert management circuitry 210, model management circuitry 212, and suggestion management circuitry 214. In some embodiments, the apparatus 200 is configured, using one or more of the processor 202, memory 204, input/output circuitry 206, communications circuitry 208, alert management circuitry 210, model management circuitry 212, and suggestion management circuitry 214, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with automatic segmentation of service case recommendations, for example into remotely performable maintenance suggestions and non-remotely performable maintenance suggestions. In some embodiments, the processor 202 includes hardware, software, firmware, and/or a combination thereof, that identifies at least one service case recommendation associated with an asset. Additionally or alternatively, in some embodiments, the processor 202 includes hardware, software, firmware, and/or a combination thereof, that processes the at least one service case recommendation via an intelligence machine learning model. Additionally or alternatively, in some embodiments, the processor 202 includes hardware, software, firmware, and/or a combination thereof, that determines at least one maintenance suggestion via the intelligence machine learning model. Additionally or alternatively, in some embodiments, the processor 202 includes hardware, software, firmware, and/or a combination thereof, that outputs at least one notification associated with the at least one maintenance suggestion.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more assets or accompanying sensor(s), and/or other external computing device in communication with the apparatus 200.

The alert management circuitry 210 includes optional hardware, software, firmware, and/or a combination thereof, that supports performing generation and/or tracking of asset alerts. For example, in some embodiments, the alert management circuitry 210 includes hardware, software, firmware, and/or a combination thereof, that accesses one or more asset alerts associated with at least one asset of a monitored environment. Each asset alert may identify alert generation rule or alert generation rules triggered to generate the asset alert. Additionally or alternatively, in some embodiments, the alert management circuitry 210 includes hardware, software, firmware, and/or a combination thereof, that receives one or more service case recommendations associated with one or more triggered alert generation rules corresponding to generated asset alerts. In some embodiments, the one or more service case recommendations are retrieved from at least one database or other data structure that links at least one alert generation rule, and/or one or more asset alerts corresponding to at least one triggered alert generation rule, with one or more corresponding service case recommendations. Additionally or alternatively, in some embodiments, the alert management circuitry 210 includes hardware, software, firmware, and/or a combination thereof, that receives operational data associated with at least one asset. Additionally or alternatively, in some embodiments, the alert management circuitry 210 includes hardware, software, firmware, and/or a combination thereof, that processes operational data to trigger one or more alert generation rules based at least in part on the operational data and/or data derived therefrom. In some embodiments, the alert management circuitry 210 includes a separate processor, specially configured field programmable gate array (FPGA), or a specially programmed application specific integrated circuit (ASIC).

The model management circuitry 212 includes hardware, software, firmware, and/or a combination thereof, that supports training, maintenance, and/or use of at least one model utilized to automatically segregate service case recommendations based on one or more classifications. For example, in some embodiments, the model management circuitry 212 includes hardware, software, firmware, and/or a combination thereof, that maintains an intelligence machine learning model utilized to automatically segregate service case recommendations to a classification of remotely performable or non-remotely performable. Additionally or alternatively, in some embodiments, the intelligence machine learning model is utilized to output at least one maintenance suggestion, and/or identify at least one remotely performable maintenance suggestion and/or at least one non-remotely performable maintenance suggestion. Additionally or alternatively, in some embodiments, the model management circuitry 212 includes hardware, software, firmware, and/or a combination thereof, that maintains at least one natural language processing model for use in processing text data in a natural language format and/or generating text data in a natural language format. Additionally or alternatively, in some embodiments, the model management circuitry 212 includes hardware, software, firmware, and/or a combination thereof, that applies particular data to the natural language processing model and/or intelligence machine learning model. Additionally or alternatively, in some embodiments, the model management circuitry 212 includes hardware, software, firmware, and/or a combination thereof, that trains or otherwise specially configures an intelligence machine learning model based at least in part on a set of training data. Additionally or alternatively, in some embodiments, the model management circuitry 212 includes hardware, software, firmware, and/or a combination thereof, that trains a natural language processing model. In some embodiments, the model management circuitry 212 includes a separate processor, specially configured field programmable gate array (FPGA), or a specially programmed application specific integrated circuit (ASIC).

The suggestion management circuitry 214 includes hardware, software, firmware, and/or a combination thereof, that supports automatic segregation of service case recommendations and outputting of particular maintenance suggestions. For example, in some embodiments, the suggestion management circuitry 214 includes hardware, software, firmware, and/or a combination thereof, that applies one or more service case recommendations, or optionally one or more service case recommendations and user configuration data, to an intelligence machine learning model that outputs at least one maintenance suggestion classified as a remotely performable maintenance suggestion or a non-remotely performable maintenance suggestion. Additionally or alternatively, in some embodiments, the suggestion management circuitry 214 includes hardware, software, firmware, and/or a combination thereof, that maintains and/or updates at least one weighting associated with at least one service case recommendation, where the weighting corresponding to a service case recommendation indicates a likelihood that the service case recommendation is remotely performable, for example. Additionally or alternatively, in some embodiments, the suggestion management circuitry 214 includes hardware, software, firmware, and/or a combination thereof, maintains and/or updates the weighting for a particular service case recommendation utilizing an intelligence machine learning model. Additionally or alternatively, in some embodiments, the suggestion management circuitry 214 includes hardware, software, firmware, and/or a combination thereof, that receives user review data associated with at least one maintenance suggestion. Additionally or alternatively, in some embodiments, the suggestion management circuitry 214 includes hardware, software, firmware, and/or a combination thereof, that processes received user review data to update at least one weighting or update an intelligence machine learning model. Additionally or alternatively, in some embodiments, the suggestion management circuitry 214 includes hardware, software, firmware, and/or a combination thereof, that performs one or more processes utilizing an outputted maintenance suggestion, for example outputting one or more notifications associated with the maintenance suggestion, automatically initiating the maintenance suggestion, and/or the like as described herein. In some embodiments, the suggestion management circuitry 214 includes a separate processor, specially configured field programmable gate array (FPGA), or a specially programmed application specific integrated circuit (ASIC).

Additionally or alternatively, in some embodiments, two or more of the sets of circuitries embodying processor 202, memory 204, input/output circuitry 206, communications circuitry 208, alert management circuitry 210, model management circuitry 212, and/or suggestion management circuitry 214 are combinable. Alternatively or additionally, in some embodiments, one or more of the sets of circuitry perform some or all of the functionality described associated with another component. For example, in some embodiments, two or more of the processor 202, memory 204, input/output circuitry 206, communications circuitry 208, alert management circuitry 210, model management circuitry 212, and/or suggestion management circuitry 214, are combined into a single module embodied in hardware, software, firmware, and/or a combination thereof. Similarly, in some embodiments, one or more of the sets of circuitry, for example the alert management circuitry 210, model management circuitry 212, and/or suggestion management circuitry 214, is/are combined with the processor 202 such that the processor 202 performs one or more of the operations described above with respect to each of the alert management circuitry 210, model management circuitry 212, and/or suggestion management circuitry 214.

### Example Data Environments of the Disclosure

Having described example systems and apparatuses in accordance with the disclosure, example data environments will now be described. In some embodiments, the example data environments include one or more software applications executed on particular hardware that facilitates the functionality described with respect to the particular data environment. For example, in some embodiments the data environments are embodied by software applications executed on the applications and/or systems described with respect to FIG. 1 and FIG. 2 to facilitate the functionality for automatically segregating service case recommendations. In some embodiments, the data environments include software-maintained data objects that are processed via computer-implemented methods implemented on such systems and/or apparatuses described herein.

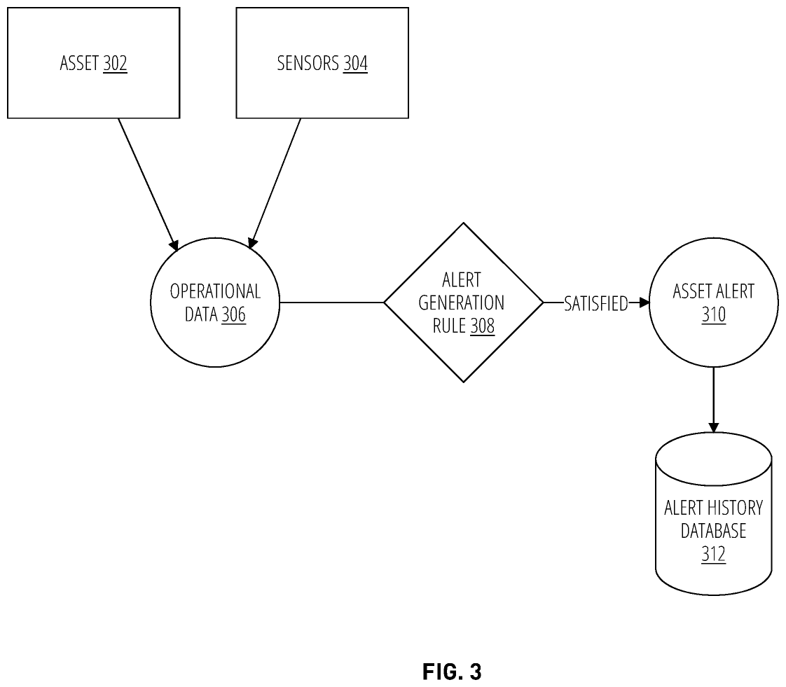

FIG. 3 illustrates an example data flow for generation of one or more asset alerts based on asset operation in accordance with at least one embodiment of the present disclosure. Specifically, FIG. 3 depicts triggering generation of an asset alert associated with an asset 302. The asset 302 corresponds to one or more sensors 304, where the sensors 304 monitor operations of the asset 302 as the asset 302 is performing. In some embodiments, the asset 302 embodies a machine, robot, or other processing unit that operates as part of an industrial process performed in a monitored environment, for example where the industrial process creates a final product from one or more input products. In some embodiments, the sensors 304 include a pressure sensor, temperature sensor, movement sensor, rotational or linear speed sensor, a counting sensor (e.g., counting a number of outputs produced by the asset 302), and/or one or more custom sensors that detect any measurable value.

The asset 302 and/or the sensors 304 measure, detect, or otherwise generate operational data 306. In this regard, in some embodiments the operational data 306 include raw data values associated with operation of the asset 302. In some embodiments, the asset 302 and/or the sensors 304 provide operational data 306 in real-time as such data is determined via the asset 302 and/or sensors 304. In some embodiments, the asset 302 and/or sensors 304 transmit (e.g., via a wired and/or wireless communication network) the operational data 306 to a centralized monitoring system for processing, for example the asset management system 102 and/or asset alerting system 112. For example, in some embodiments the asset 302 and/or sensors 304 transmit the operational data 306 to the apparatus 200 for processing as depicted and described herein.

In some embodiments, the operational data 306 is processed to determine one or more data values for one or more performance metrics associated with the asset 302. In some embodiments, the performance metrics for a particular asset are predetermined. In some embodiments, for example, an asset type of the asset 302 is utilized to identify particular performance metrics associated with the asset 302. Additionally or alternatively, in some embodiments, the performance metrics associated with the asset 302 are determinable based at least in part on an identifier or other data specific to the asset 302.

The operational data 306, and/or performance metrics and/or other data derived therefrom, is processed by the alert generation rule 308. The alert generation rule 308 may include one or more data-driven determinations that, if satisfied, indicate a performance issue associated with the asset 302. For example, in some embodiments, the alert generation rule 308 includes one or more equations or conditionals that, when satisfied, indicate that the asset 302 is operating in a degraded state, non-functional, or otherwise undesirable state. In this regard, generation of asset alerts may indicate that the asset 302 is operating in a state that requires maintenance to return the asset 302 to a nominal or otherwise desirable operational state.

As illustrated, some embodiments such as the apparatus 200 generate the asset alert 310 in a circumstance where the alert generation rule 308 is satisfied. In some embodiments, the asset alert 310 includes data identifying the alert generation rule 308 that was satisfied, timestamp data for the time at which the alert generation rule 308 was satisfied or at which the operational data 306 was received that was then processed for satisfaction of the alert generation rule 308, and/or the like. Additionally or alternatively, in some embodiments, the asset alert 310 indicates a particular malfunction or problem determined or predicted to be affecting the asset 302 based at least in part on satisfaction of the alert generation rule 308. In some embodiments, a problem or malfunction associated with the asset 302 is determinable from a combination of asset alerts including at least the asset alert 310 and one or more other asset alerts generated corresponding to the asset 302.

In some embodiments, one or more notifications in response to the asset alert 310 are generated. For example, in some embodiments, generation of the asset alert 310 triggers a notification transmitted as a text message, user interface, email, or other data accessible by an end user via a user device. For example, in some embodiments, the notification associated with the asset alert 310 is generated identifying the particular asset alert 310 generated, the alert generation rule 308 that was satisfied, and/or indicating that maintenance of the asset 302 is required. The notification associated with the asset alert 310 in some embodiments is transmitted to the user device for outputting via at least one user interface rendered to a display of the user device.

Some embodiments store the asset alert 310 in an alert history database 312. In some embodiments, the apparatus 200 stores the asset alert 310 as part of alert history data maintained via the alert history database 312. In this regard, the alert history database 312 may store alert history data corresponding to each asset in at least one monitored environment, for example including at least the asset 302. In some embodiments, the alert history data for a particular asset includes each asset alert, for example the asset alert 310, generated corresponding to that particular asset. For example, the alert history database 312 may store first alert history data including each asset alert corresponding to the asset 302, second alert history data including each asset alert corresponding to a second asset, and the like. Additionally or alternatively, in some embodiments, an asset alert 310 is stored associated with a plurality of assets, for example in a circumstance where the alert generation rule 308 is indicative of a malfunction contributed to by a plurality of assets, for example assets of particular asset types and/or the like.

In some embodiments, the alert history database 312 is configured to store or otherwise includes one or more other portions of data associated with the asset alerts and/or satisfied alert generation rules that generated the asset alerts for a particular asset. For example, in some embodiments, the alert history database 312 includes data identifying the corresponding alert generation rule that was satisfied to trigger generation of an asset alert. Additionally or alternatively, in some embodiments, the alert history database 312 maintains data linking an asset alert and/or an alert generation rule with one or more service case recommendations associated with that asset alert and/or associated alert generation rule. In some embodiments, each service case recommendation represents at least one particular maintenance action recommended to perform as part of maintenance of the asset to attempt to resolve a determined operational issue associated with the asset as indicated by the asset alert and/or satisfied alert generation rule.

The alert history database 312 may be accessible to the apparatus 200 for further processing, for example to retrieve particular alert history data during automatically segregating service case recommendations into remotely performable maintenance suggestions and non-remotely performable maintenance suggestions. In some embodiments, the apparatus 200 generates and/or maintains the alert history database 312 in as depicted and described in FIG. 3. In some embodiments, the alert history database 312 is maintained by a separate system, for example embodied by the asset alerting system 112 as described herein, and made available to the apparatus 200 for processing at least during processes for automatically segregating maintenance service case recommendations.

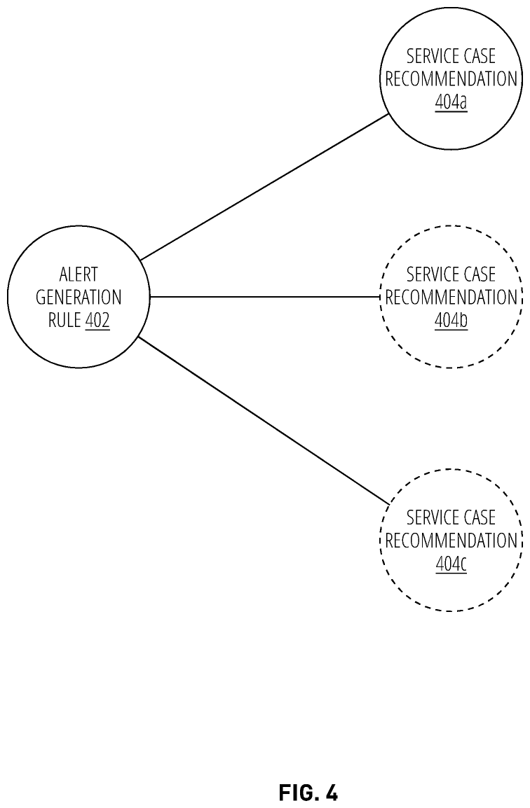

FIG. 4 illustrates a representation of a link between an alert generation rule and at least one service case recommendation corresponding to the alert generation rule accordance with at least one embodiment of the present disclosure. Specifically, FIG. 4 depicts service case recommendations corresponding to a particular alert generation rule 402. In some embodiments, the apparatus 200 and/or asset alerting system 112 maintains data embodying a link between a particular alert generation rule and the service case recommendations corresponding to that alert generation rule. In this regard, in some embodiments data identifying an alert generation rule triggered by the operational data of a particular asset is usable to determine service case recommendations corresponding to that alert generation rule.

In some embodiments, the apparatus 200 and/or asset alerting system 112 maintains at least one database including data linking at least one alert generation rule with at least one corresponding service case recommendation. For example, in some embodiments, the apparatus 200 and/or asset alerting system 112 associated therewith maintains a database including at least one data record identifying the alert generation rule 402 and linked to at least one data record for each service case recommendation linked to the alert generation rule 402. As illustrated, the alert generation rule 402 is associated with at least service case recommendation 404A, and optionally with service case recommendation 404b and service case recommendation 404c. It should be appreciated that a particular alert generation rule may be linked to any number of associated service case recommendations. Each service case recommendation may represent a particular one or more maintenance actions that are determined or otherwise indicated for resolving one or more operational problems associated with a corresponding asset based on the satisfaction of the alert generation rule 402, of the service case recommendation 404a, service case recommendation 404b, and service case recommendation 404c. In some embodiments, the links associated with the alert generation rule 402 may be queried to determine the service case recommendations that correspond to that alert generation rule 402 as possible recommended fixes. For example, in some embodiments, in a circumstance where alert generation rule 402 embodies a rule where a VAV zone tempt is less than a setpoint by 5 degrees Fahrenheit, an associated AHU discharge temperature is satisfied, and such conditions are true for more than 3-minutes two or more times in a day or 60 minutes once a day, the service case recommendation 404a embodies a maintenance action to check if an AHU DA temperature setpoint is set to a lower value, service case recommendation 404b embodies a maintenance action to check a sensor location or any external influence (e.g., infiltration or exfiltration), and service case recommendation 404c embodies a maintenance action to check if a flow SP is per design as intended. It will be appreciated that a particular alert generation rule may be associated with any number of service case recommendations, each service case recommendation defining one or more maintenance action to take in maintaining at least one asset in response to triggering of the corresponding alert generation rule.

In some embodiments, the apparatus 200 establishes links between an alert generation rule and at least one service case recommendation corresponding to that alert generation rule. For example, in some embodiments, the links between an alert generation rule and at least one service case recommendation are determined or otherwise inputted by a particular user, for such as a subject matter expert associated with the alert generation rule and/or a particular asset. Additionally or alternatively, in some embodiments, the links between an alert generation rule and at least one service case recommendation are determined based at least in part on previously performed maintenance actions detected in response to asset alerts generated from the triggered alert generation rule. Additionally or alternatively, in some embodiments the links between an alert generation rule and at least one service case recommendation is received from at least one external system.

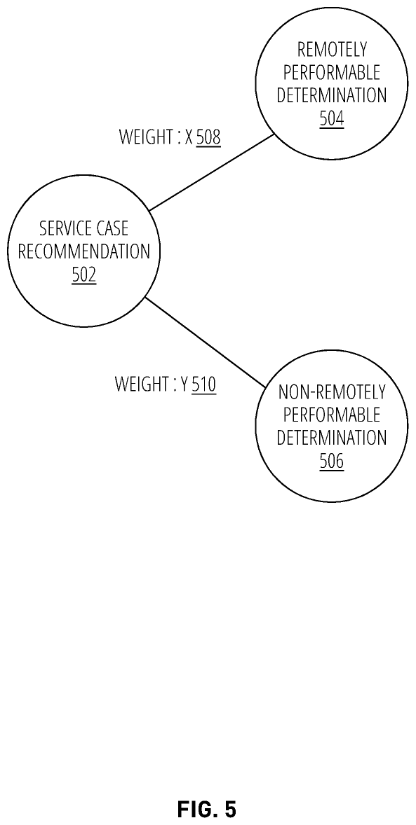

FIG. 5 illustrates a representation of weightings associated with whether a service case recommendation is remotely performable in accordance with at least one embodiment of the present disclosure. Specifically, FIG. 5 depicts associations between a service case recommendation 502 and at least one weight indicating whether the service case recommendation is remotely performable. In some embodiments, a single weighting represents a likelihood that the service case recommendation 502 is remotely performable, for example the weighting 508. In some such embodiments, the single weighting may be utilized to determine a second weighting indicating a likelihood that the service case recommendation 502 is non-remotely performable, for example by subtracting the percentage represented by weighting 508 from 100%. Additionally or alternatively, in some embodiments, the apparatus 200 maintains two separate weightings, for example a weighting 508 that indicates a likelihood that the service case recommendation 502 is remotely performable and a second weighting 510 indicating a likelihood that the service case recommendation 502 is non-remotely performable. In some embodiments, the service case recommendation 502 is maintained via at least one data record that includes or otherwise is linked with the weighting 508 (and/or the weighting 510, for example in a circumstance where the apparatus 200 maintains two separate weightings indicating a likelihood of being remotely performable and a likelihood of being non-remotely performable, respectively.

In some embodiments, at least one weighting associated with the service case recommendation 502 is set to an initial value before further processing via the apparatus 200, an intelligence machine learning model, and/or the like. For example, in some embodiments, each service case recommendation is set to a default value determined by the apparatus 200 or otherwise predetermined. In some embodiments, each weighting is set to a default value indicated or otherwise set by a user of the apparatus 200. Additionally or alternatively still, in some embodiments the default value set for the service case recommendation 502 is determined by the apparatus 200 itself. For example, in some embodiments, the apparatus 200 processes text data of the service case recommendation 502 using a natural language processing model to determine the default value assigned to the service case recommendation 502. In some embodiments, the natural language processing model is configured to process the text data of the service case recommendation 502 where the text data is in a natural language format. In some such embodiments, the natural language processing model processes the service case recommendation 502 to detect particular keywords, statements, and/or the like within the text data, and generate a value for the weighting 508 associated with the service case recommendation 502 based at least in part on whether such keywords, statements, and/or the like were detected within the text data.

In some embodiment, the value of the weighting assigned to or otherwise linked to service case recommendation 502 is updated as the service case recommendation 502 is processed for one or more iterations, for example via an intelligence machine learning model to determine whether to output the service case recommendation 502 as a remotely performable maintenance suggestion. In this regard, in some embodiments the apparatus 200 updates the weighting 508 to maintain an updated likelihood that the service case recommendation 502 is remotely performable based at least in part on each performed iteration of processing the service case recommendation 502 and/or data derived or otherwise associated therewith. For example, in some embodiments, the apparatus 200 updates at least one weighting, such as the weighting 508 or in some embodiments both the weighting 508 and weighting 510, associated with the service case recommendation 502 in response to user configuration data indicating performed maintenance actions and/or user review data received in response to outputted maintenance suggestions. In some such embodiments, for example, the apparatus 200 update the weighting 508 (and/or lowers the weighting 510) to increase the value of the weighting 508 in a circumstance where user configuration data is received indicating that a user performed the service case recommendation 502 as a maintenance action in response to a remotely performable maintenance suggestion. Additionally or alternatively, in some such embodiments the apparatus 200 updates the weighting 508 (and/or lowers the weighting 510) to increase the value of the weighting 508 in a circumstance where user review data indicating that the service case recommendation 502 is remotely performable is received from a reviewer in response to the output of a remotely performable maintenance suggestion representing the service case recommendation 502. Similarly, it will be appreciated that in either such case, the weighting 508 may be decreased (and/or the weighting 510 may be increased) in a circumstance where user review data indicating that the service case recommendation 502 is non-remotely performable is received from a reviewer in response to the output of a remotely performable maintenance suggestion representing the service case recommendation 502.

In some embodiments, at least one weighting associated with the service case recommendation 502 is utilized to determine whether the service case recommendation 502 is always remotely performable, or whether the at least one service case recommendation is always not remotely performable. For example, in some embodiments, at least one weighting associated with the service case recommendation 502 is compared to at least one threshold to determine whether the service case recommendation 502 is always remotely performable. In some such embodiments, the apparatus 200 determines that the service case recommendation 502 is always remotely performable in a circumstance where the weighting 508 is determined to satisfy (e.g., by exceeding) a corresponding threshold. Additionally or alternatively, in some embodiments, the apparatus 200 determines that the service case recommendation 502 is always not remotely performable in a circumstance where the weighting 508, or the weighting 510 stored separately or derived from the weighting 508, is determined to satisfy (e.g., by falling below in the circumstance of weighting 508, or by exceeding in the circumstance of weighting 510) a second corresponding threshold. For example, in some embodiments the apparatus 200 determines that the service case recommendation 502 is always remotely performable in a circumstance where the weighting 508 exceeds a threshold of 0.95, or determines that the service case recommendation 502 is always non-remotely performable in a circumstance where the weighting 508 falls below a threshold of 0.05.

In some embodiments, the apparatus 200 maintains one or more service case recommendations associated with a data flag indicating a remotely performable determination 504 or a non-remotely performable determination 506. For example, in some embodiments, the apparatus 200 stores the service case recommendation 502 associated with the remotely performable determination 504 or non-remotely performable determination 506 in a circumstance where the one or more corresponding thresholds are satisfied, such that further maintenance or updating of the weightings associated with the service case recommendation 502 are no longer required. In this regard, in some embodiments the apparatus 200 may cease updating of the weightings after such determinations. In some embodiments, one or more service case recommendations are assigned or otherwise associated with the remotely performable determination 504 as always remotely performable or non-remotely performable determination 506 as always non-remotely performable by default, for example in response to input from a user (e.g., an industry expert) or data retrieved from a trusted knowledge base indicating that the service case recommendation is always remotely performable or always non-remotely performable.

Service case recommendations that satisfy a corresponding threshold indicating that the service case recommendation is remotely performable may subsequently be automatically segregated as remotely performable, and always outputted as a remotely performable maintenance suggestion. Similarly, service case recommendations that satisfy a corresponding threshold indicating that the service case recommendation is non-remotely performable may subsequently be automatically segregated as non-remotely performable, and always outputted as a non-remotely performable maintenance suggestion. In some embodiments, non-remotely performable maintenance suggestions are not outputted in a circumstance where at least one remotely performable maintenance suggestion is identifiable, as depicted and described herein.

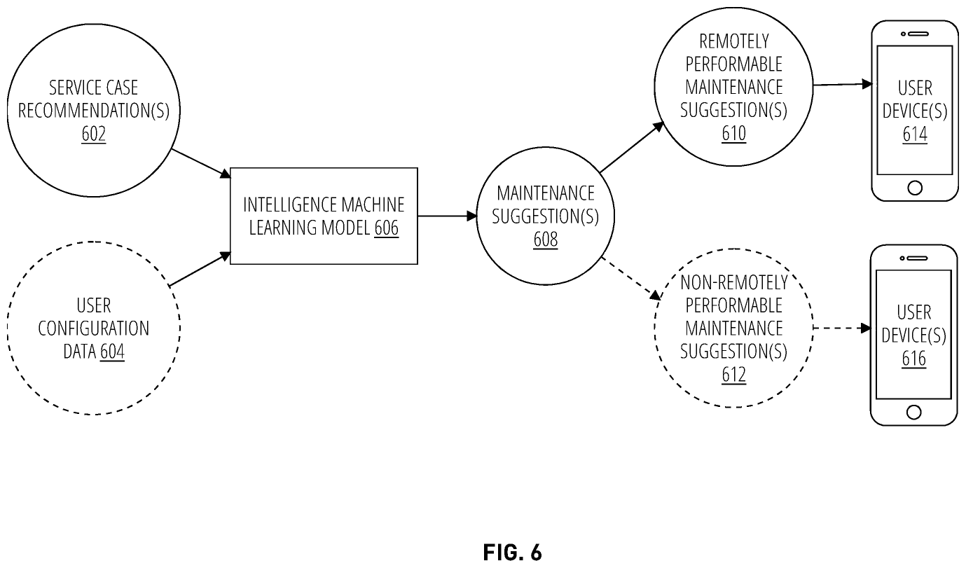

FIG. 6 illustrates an example data flow for automatically segregating maintenance suggestions in accordance with at least one embodiment of the present disclosure. Specifically, FIG. 6 depicts automatically segregating maintenance suggestions utilizing a specially trained intelligence machine learning model 606. For example, in some embodiments the apparatus 200 performs automatically segregating maintenance suggestions via the depicted data flow in response to asset alerts generated for at least one asset. Additionally or alternatively, in some embodiments, the apparatus 200 performs the depicted data flow to automatically segregate maintenance suggestions for each asset of a plurality of assets.

FIG. 6 depicts portions of input data for applying to the intelligence machine learning model 606. In some embodiments, the input data includes at least service case recommendation(s) 602. In some embodiments, the service case recommendation(s) 602 includes one or more service case recommendations linked to a particular triggered alert generation rule and/or generated asset alert. For example, in some embodiments the apparatus 200 identifies and/or retrieves particular asset alerts corresponding to triggered alert generation rules, and determines the service case recommendation(s) 602 by querying for service case recommendations linked to the asset alerts. In this regard, the service case recommendation(s) 602 may include all service case recommendations for a particular asset alert, or plurality of asset alerts, embodying a universe of possible maintenance actions for maintaining at least one asset corresponding to one or more generated asset alerts.

Additionally or alternatively, in some embodiments, the input data optionally includes at least user configuration data 604. In some embodiments, the user configuration data 604 includes data indicating whether a particular user, for example a remote user, remotely initiated a remotely performable maintenance suggestion. Additionally or alternatively, in some embodiments the user configuration data 604 includes data indicating service case recommendations including maintenance actions that were performed to resolve at least one asset alert generated in response to a triggered alert generation rule. For example, in some embodiments, the user configuration data 604 is detected and/or tracked by the apparatus 200 and/or an associated system, such as the asset alerting system 112 as depicted and described, as maintenance of a particular asset is completed. In some such embodiments, the apparatus 200 maintains a database including the user configuration data 604.

FIG. 6 depicts a plurality of portions of input data including service case recommendation(s) 602 and user configuration data 604. In some embodiments one or more portions of the input data are predetermined or otherwise statically available to the apparatus 200, for example at least the service case recommendation(s) 602 or user configuration data 604. Additionally or alternatively, in some embodiments, one or more portions of the input data is retrievable and/or received from a database that is accessible to the apparatus 200 and stores such data previously received by the apparatus 200. For example, in some embodiments, the apparatus 200 accesses a database of alert history data and/or associated data to receive the service case recommendation(s) 602, and/or accesses a database of user configuration data associated with particular asset alerts, assets, and/or the like.

The apparatus 200 applies the service case recommendation(s) 602 and user configuration data 604 to the intelligence machine learning model 606. In some embodiments, the intelligence machine learning model 606 includes a specially configured machine learning model, rule set, algorithmic model, and/or the like. The intelligence machine learning model 606 is specially configured to automatically output at least one maintenance suggestion, such as the maintenance suggestion(s) 608. The maintenance suggestion(s) 608 in some embodiments represents particular service case recommendations from the service case recommendation(s) 602 that are determined to include particular maintenance actions preferred for performing maintenance of one or more assets associated with the asset alerts corresponding to the service case recommendation(s) 602. In accordance with various embodiments of the present disclosure, an intelligence machine learning model may comprise one or more of Naive Bayes classifiers, Support Vector Machines (SVMs), decision trees, random forest, Convolutional Neural Networks (CNNs), Recurrent Neural Networks (RNNs), and/or the like.

In some embodiments, the intelligence machine learning model 606 automatically segregate at least a portion of the service case recommendation(s) 602 to output particular maintenance suggestions from the service case recommendation(s) 602. For example, in some embodiments, the intelligence machine learning model 606 automatically segregates the service case recommendation(s) 602 to output one or more remotely performable maintenance suggestions for resolving one or more asset alerts generated in response to triggered alert generation rules for a particular asset or plurality of assets. In some embodiments, the intelligence machine learning model 606 outputs maintenance suggestion(s) 608 embodying one or more remotely performable maintenance suggestion in a circumstance where at least one remotely performable maintenance suggestion is determined from the service case recommendation(s) 602. Additionally or alternatively, in circumstances where the intelligence machine learning model 606 determines that no remotely performable maintenance suggestions are present in the service case recommendation(s) 602, the intelligence machine learning model 606 may output maintenance suggestion(s) 608 embodying one or more non-remotely performable maintenance suggestions. Each remotely performable maintenance suggestion in some embodiments includes one or more maintenance actions including at least one remotely performable maintenance actions, and/or entirely including only remotely performable maintenance actions. Similarly, each non-remotely performable maintenance suggestion in some embodiments includes one or more maintenance actions including at least one non-remotely performable maintenance actions, and/or entirely including non-remotely performable maintenance actions.

In some embodiments, the intelligence machine learning model 606 is configured based at least in part on a training phase to perform the automatic segregation of the service case recommendation(s) 602 into remotely performable maintenance suggestions and/or non-remotely performable maintenance suggestions. Additionally or alternatively, in some embodiments, the intelligence machine learning model 606 may determine one or more of the service case recommendation(s) 602 is not determinable as remotely performable or non-remotely performable, and instead may assign a likelihood that each of the one or more service case recommendations is remotely performable. Embodiments identify whether a service case recommendation is likely to be remotely performable to obtain the various advantages with respect to speed of implementation, computing resource and other resource expenditure for facilitating non-remote maintenance, and/or to enable automatic initiation of at least one recommendation to resolve one or more faults for at least one asset.

In some embodiments, the intelligence machine learning model 606 processes one or more portions of the input data at least in part utilizing a natural language processing model. For example, in some embodiments the intelligence machine learning model 606 processes the service case recommendation(s) 602 using a natural language processing model to extract and/or process particular keywords, statements, phrases, sentiments, and/or the like from text data in a natural language format of a particular service case recommendation. Additionally or alternatively, in some embodiments the intelligence machine learning model 606 processes the user configuration data 604 using a natural language processing model to extract and/or process particular keywords, statements, phrases, sentiments, and/or the like from particular user-inputted notes or other text data in a natural language format. For example, in some embodiments, the natural language processing model processes text data of each service case recommendation to attempt identification of keywords such as overrides, manual operation, check, look, and/or the like. The intelligence machine learning model 606 may be configured to learn that identification of such keywords increases the predicted likelihood that the corresponding service case recommendation is remotely performable.

In some embodiments, the intelligence machine learning model 606 is trained by the apparatus 200. Additionally or alternatively, in some embodiments, the intelligence machine learning model 606 is trained by an external system that provides the apparatus 200 access to the trained intelligence machine learning model 606, or provides the intelligence machine learning model 606 upon completion of training to the apparatus 200 for storage. It will be appreciated that the intelligence machine learning model 606 may be trained utilizing supervised learning techniques, for example based at least in part on labeled input data and indications of whether such data indicates a service case recommendation is remotely performable, and/or unsupervised learning techniques.

In some embodiments, the intelligence machine learning model 606 automatically segregates the maintenance suggestion(s) 608 into distinct classifications. For example as illustrated, in some embodiments the intelligence machine learning model 606 particularly segregates the service case recommendation(s) 602 to output remotely performable maintenance suggestion(s) 610. Additionally or alternatively, in some embodiments, the intelligence machine learning model 606 optionally particularly segregates the service case recommendation(s) 602 to output non-remotely performable maintenance suggestion(s) 612. In some embodiments, the intelligence machine learning model 606 segregates the maintenance suggestion(s) 608 from the service case recommendation(s) 602 into a first classification embodying the remotely performable maintenance suggestion(s) 610 and a second classification embodying the non-remotely performable maintenance suggestion(s) 612.

The apparatus 200, for example via the intelligence machine learning model 606 and/or one or more post-processing operations, outputs at least a portion of data based at least in part on the remotely performable maintenance suggestion(s) 610. For example, in some embodiments, the apparatus 200 outputs the remotely performable maintenance suggestion(s) 610 to a display of the apparatus 200. Additionally or alternatively, in some embodiments, the apparatus 200 outputs at least one notification associated with at least one remotely performable maintenance suggestion. The notification may indicate particular remotely performable maintenance actions determined based on the remotely performable maintenance suggestion(s) 610 to perform during remote access of a particular asset or plurality of assets to maintain the particular asset or plurality of assets.

As depicted, the apparatus 200 outputs the remotely performable maintenance suggestion(s) 610 to one or more user device(s) 614. In some embodiments, the user device(s) 614 embodies a user device owned, possessed, or otherwise operated by a maintainer remotely located from a particular asset corresponding to the service case recommendation(s) 602. In some embodiments, for example, the apparatus 200 outputs the one or more notifications to the user device(s) 614 for rendering via one or more user interfaces on the user device(s) 614. In some embodiments, the one or more notifications include email notifications, text notifications, push notifications, dynamic updates to a real-time interface of an executed application, and/or the like. In this regard, the user associated with the user device(s) 614 (e.g., a maintainer responsible for remotely attempting maintenance of at least a particular asset, and/or dispatching one or more other maintainers responsible for physically interacting with the asset to perform maintenance) may utilize the same user device(s) 614 and/or a separate computing device to perform remote maintenance of at least one asset based at least in part on the maintenance actions represented in the remotely performable maintenance suggestion(s) 610.

Additionally or alternatively, in some embodiments the apparatus 200, via the intelligence machine learning model 606 and/or via one or more post-processing operations, outputs at least a portion of data based at least in part on the non-remotely performable maintenance suggestion(s) 612. For example, in some embodiments, the apparatus 200 outputs the non-remotely performable maintenance suggestion(s) 612 to a display of the apparatus 200. Additionally or alternatively, in some embodiments, the apparatus 200 outputs at least one notification associated with at least one non-remotely performable maintenance suggestion. The notification may indicate particular non-remotely performable maintenance actions determined based on the non-remotely performable maintenance suggestion(s) 612 to perform during a physical interaction with at least one asset to perform maintenance.

As depicted, the apparatus 200 outputs the non-remotely performable maintenance suggestion(s) 612 to one or more user device(s) 616. In some embodiments, the user device(s) 616 embodies a user device owned, possessed, or otherwise operated by a maintainer located on-site with or responsible for physically interacting with at least one particular asset to perform maintenance of that asset. In some embodiments, for example, the apparatus 200 outputs one or more notifications generated corresponding to the non-remotely performable maintenance suggestion(s) 612 for rendering via one or more user interfaces on the user device(s) 616. In some embodiments, the one or more notifications include email notifications, text notifications, push notifications, dynamic updates to a real-time interface of an executed application, and/or the like. In this regard, the user associated with the user device(s) 616 (e.g., a maintainer responsible for physically interacting with at least one asset in the real-world to perform maintenance) may utilize the user device(s) 616 to receive data indicative of one or more particular assets require maintenance, and/or data indicative of particular non-remotely performable maintenance actions to be performed during physical interaction with the particular asset(s). Additionally or alternatively, in some embodiments, the apparatus 200 additionally outputs the non-remotely performable maintenance suggestion(s) 612 to the user device(s) 614 for use by a remote maintainer associated with one or more assets.

In some embodiments, data associated with the remotely performable maintenance suggestion(s) 610 is outputted with higher priority than the non-remotely performable maintenance suggestion(s) 612. For example, in some embodiments, the apparatus 200 outputs only the remotely performable maintenance suggestion(s) 610 in a circumstance where at least one remotely performable maintenance suggestion(s) 610 is determined. In some such embodiments, the apparatus 200 may only output the non-remotely performable maintenance suggestion(s) 612 in a circumstance where no remotely performable maintenance suggestion(s) 610 is determined. Additionally or alternatively, in some embodiments, the apparatus 200 outputs the non-remotely performable maintenance suggestion(s) 612 in response to a request received via the user device(s) 614, for example where the request indicates that the remotely performable maintenance suggestion(s) 610 are insufficient or did not resolve performance issues associated with one or more assets.

In some embodiments, the intelligence machine learning model 606 receives or otherwise retrieves previously-stored data embodying a previous classification or weighting for each of one or more service case recommendation. Such data may define a starting point for determining a classification of each service case recommendation. As the intelligence machine learning model 606 outputs maintenance suggestions, and feedback data is provided, such weighting for a service case recommendation is updated to prioritize the insight provided by the feedback data of the user. Additionally or alternatively, in some embodiments, the service case recommendation includes and/or is processed to determine root cause and/or resolution code that is utilized as a secondary input to validate the provided feedback data, for example by the intelligence machine learning model 606.

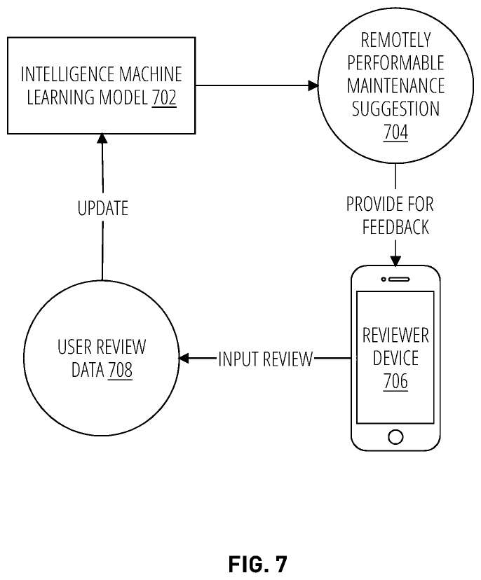

FIG. 7 illustrates an example data flow for updating determination of remotely performable maintenance suggestions based at least in part on user review data in accordance with at least one embodiment of the present disclosure. Specifically, FIG. 7 depicts updating one or more data values based at least in part on received user review data associated with a particular maintenance suggestion. For example, in some embodiments, the apparatus 200 performs the updating via the depicted data flow in response to output of a particular remotely performable maintenance suggestion corresponding to a particular asset or plurality of assets. As illustrated, the apparatus 200 determines and outputs a particular remotely performable maintenance suggestion 704 utilizing an intelligence machine learning model 702, for example where the intelligence machine learning model 702 embodies the intelligence machine learning model 606 and the remotely performable maintenance suggestion 704 embodies at least one of the remotely performable maintenance suggestion(s) 610.

In some embodiments, the apparatus 200 utilizes intelligence machine learning model 702 to determine and output the remotely performable maintenance suggestion 704 based at least in part on input data, for example as depicted and described with respect to FIG. 6. In some embodiments, the apparatus 200 transmits the remotely performable maintenance suggestion 704 to at least one reviewer device for further processing, for example the reviewer device 706. In some embodiments, the reviewer device 706 embodies a particular user device owned, possessed, or operated by a reviewer associated with a particular entity, asset, and/or the like. For example, in some embodiments, the reviewer device 706 is associated with an administrator or subject matter expert associated with a particular asset corresponding to one or more service case recommendations processed by the intelligence machine learning model 702, assets corresponding to asset alerts associated with the service case recommendations, and/or the like. In some embodiments, the reviewer device 706 is predetermined by the apparatus 200, or otherwise determinable based on data linking the reviewer device 706 to the service case recommendations, remotely performable maintenance suggestion 704, corresponding assets, and/or corresponding asset alerts.

In some embodiments, the reviewer device 706 is configured to render a particular user interface in response to receiving the remotely performable maintenance suggestion 704. In some embodiments, the user interface is configured to display or otherwise depict the remotely performable maintenance suggestion 704 to the user of the reviewer device 706. Additionally or alternatively, in some embodiments, the user interface rendered to the reviewer device 706 is configured to enable input of particular user review data. As depicted for example, the user of the reviewer device 706 may interact with the reviewer device 706 to input the user review data 708. For example, in some embodiments, the reviewer device 706 renders one or more user interface components that indicate whether the remotely performable maintenance suggestion 704 is accurately classified as remotely performable or incorrectly classified and should be non-remotely performable.

In some embodiments, the user review data 708 embodies the response of the reviewer via the interface rendered to the reviewer device 706. For example, in some embodiments, the user review data 708 includes a first data value indicating that the remotely performable maintenance suggestion 704 is properly classified as remotely performable in response to user engagement with a first interface component rendered to the user interface displayed on the reviewer device 706. Alternatively, in some embodiments the user review data 708 includes a second data value indicating that the remotely performable maintenance suggestion 704 is not properly classified as remotely performable (e.g., is actually non-remotely performable) in response to user engagement with a second interface component rendered to the user interface displayed on the reviewer device 706.

The apparatus 200 utilizes the user review data 708 to update the intelligence machine learning model 702. In some embodiments, the remotely performable maintenance suggestion 704 is outputted for displaying and/or processing by a user device associated with a particular maintainer in a circumstance where the user review data 708 indicates that the remotely performable maintenance suggestion 704 is confirmed as remotely processable by the reviewer. Additionally or alternatively, in some embodiments, the intelligence machine learning model 702 is updated by updating one or more weightings maintained associated with the remotely performable maintenance suggestion 704 based at least in part on the user review data 708. For example, in some embodiments, the intelligence machine learning model 702 is updated such that at least one weighting associated with the remotely performable maintenance suggestion 704 (e.g., stored associated with the service case recommendation corresponding to the remotely performable maintenance suggestion 704) is increased in a circumstance where the user review data 708 indicates that the remotely performable maintenance suggestion 704 is remotely performable. In some embodiments, the intelligence machine learning model 702 is updated such that the at least one weighting associated with the remotely performable maintenance suggestion 704 is decreased in a circumstance where the user review data 708 indicates that the remotely performable maintenance suggestion 704 is not accurately classified as remotely performable. In this regard, the weighting (or multiple weightings) may be indicated to track the indication represented by the user review data 708. In some embodiments, the weighting for a particular recommendation embodied by the remotely performable maintenance suggestion 704 is continuously updated until one or more thresholds are satisfied, for example indicating that the recommendation is always remotely performable or always non-remotely performable.

Additionally or alternatively, in some embodiments the reviewer device 706 is configured to provide access to functionality associated with managing automatic segregation of the service case recommendations. In some embodiments, the reviewer device 706 may access the apparatus 200 to set one or more thresholds associated with weightings for one or more service case recommendations. For example, in some embodiments, the reviewer device 706 sets a threshold corresponding to a weighting that, if exceeded or otherwise satisfied, indicates that the corresponding service case recommendation may be determined as always remotely performable.

Additionally or alternatively still, in some embodiments, the reviewer device 706 provides access to functionality that enables a reviewer to indicate one or more particular alert generation rules corresponding to service case recommendations that are always remotely performable or service case recommendations that are always non-remotely performable. In this regard, the reviewer may utilize the reviewer device 706 to mark or otherwise indicate such alert generation rules. Asset alerts generated by such rules may then trigger outputting of service case recommendations that are automatically segregated into classifications determined based on the input from the reviewer.

### Example Processes of the Disclosure

Having described example systems and apparatuses, data representations and visualizations, and data flows in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

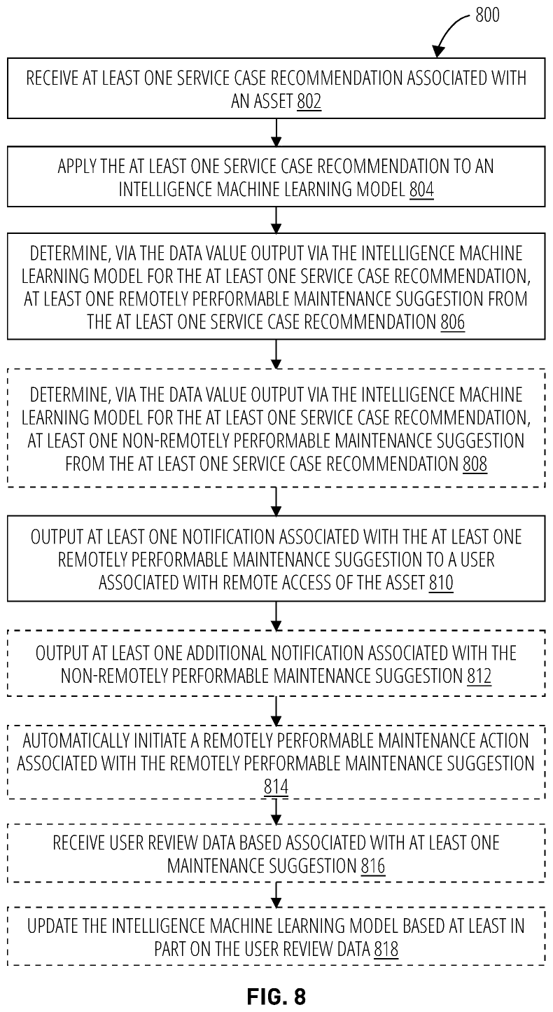

FIG. 8 illustrates operations of an example process in accordance with at least one embodiment of the present disclosure. Specifically, FIG. 8 depicts operations of an example process 800. In some embodiments, the process 800 is embodied by computer program code stored on a non-transitory computer-readable storage medium of a computer program product configured for execution to perform the process as depicted and described. Alternatively or additionally, in some embodiments, the process 800 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, at least one physical component, at least one processing plant system, a scheduling system, and/or the like. For purposes of simplifying the description, the process 800 is described as performed by and from the perspective of the apparatus 200.

According to some examples, the method includes receiving at least one service case recommendation associated with an asset at operation 802. In some embodiments, the at least one service case recommendation correspond to at least one asset alert generated in response to at least one triggered alert generation rule. For example, in some embodiments, the apparatus 200 queries for each at least one service case recommendation linked to a generated asset alert and/or alert generation rule corresponding to a generated asset alert. In some embodiments, each service case recommendation indicates one or more maintenance actions performable to maintain a particular asset. A maintenance action in a particular service case recommendation may be undetermined as remotely performable or non-remotely performable, or the service case recommendation may be marked as always remotely performable, or the service case recommendation may be marked as always non-remotely performable.

According to some examples, the method includes applying the at least one service case recommendation to an intelligence machine learning model at operation 804. In some embodiments, the intelligence machine learning model outputs at least one maintenance suggestion from the at least one service case recommendation. For example, in some embodiments, the intelligence machine learning model is configured to automatically segregates at least a portion of the at least one service case recommendation. In some such embodiments, the intelligence machine learning model may be configured to generate a particular data value indicating a likelihood that a service case recommendation is remotely performable (e.g., based at least in part on an associated weighting).

Additionally or alternatively, in some embodiments, user configuration data is applied to the intelligence machine learning model. In some embodiments, the user configuration data includes one or more portions of text data. For example, in some embodiments, the user configuration data includes text data in a natural language format that represents instructions or steps for performing at least one particular maintenance action. In some embodiments, the apparatus 200 processes the user configuration data utilizing a natural language processing model to derive one or more machine-interpretable data values from the user configuration data, and may apply the machine-interpretable data values to the intelligence machine learning model. For example, in some embodiments the natural language processing model extracts particular keywords, phrases, and/or the like from the user configuration data for further processing.

According to some examples, the method includes determining at least one remotely performable maintenance suggestion from the at least one service case recommendation at operation 806. For example, in some embodiments, the apparatus 200 determines that the at least one remotely performable maintenance suggestion via the data value output via the intelligence machine learning model for the at least one service case recommendation. In some embodiments, the data value for each particular service case recommendation represents at least one weighting corresponding to the particular service case recommendation. In some embodiments, the apparatus 200 compares the data value embodying a data value with a corresponding threshold. In this regard, in some embodiments the intelligence machine learning model automatically segregates the at least one remotely performable maintenance suggestion from the at least one service case recommendation identified at operation 802. In some embodiments, the apparatus 200 segregates only a subset of the at least one service case recommendation.

According to some examples, the method includes determining at least one non-remotely performable maintenance suggestion from the at least one service case recommendation at optional operation 808. For example, in some embodiments, the apparatus 200 determines that the at least one non-remotely performable maintenance suggestion via the data value output via the intelligence machine learning model for the at least one service case recommendation. In some embodiments, the data value for each particular service case recommendation represents at least one weighting corresponding to the particular service case recommendation. In some embodiments, the apparatus 200 compares the data value embodying a data value with a second threshold corresponding to the classification of non-remotely performable. In this regard, in some embodiments the intelligence machine learning model may automatically segregate the at least one non-remotely performable maintenance suggestion from the at least one service case recommendation identified at operation 802. In some embodiments, the apparatus 200 segregates only a subset of the at least one service case recommendation.

According to some examples, the method includes outputting at least one notification associated with the at least one remotely performable maintenance suggestion to a user associated with remote access of the asset at operation 810. In some embodiments, the at least one notification embodies an email notification, text notification, user interface, push notification, or the like renderable via an external computing device. For example, in some embodiments, the apparatus 200 outputs the at least one notification to a particular user device associated with the particular user. In some embodiments for example, the user device is predetermined, determined based at least in part on an asset corresponding to a triggered alert generation rule or generated asset alert, and/or otherwise identifiable by the apparatus 200. In some embodiments, the user device to which the at least one notification is output is associated with a particular user embodying a remote maintainer associated with one or more asset (e.g., that may not have physical access to the asset). For example, in some embodiments, the maintainer utilizes the user device or another computing device to perform remote access of at least the asset. During such remote access, the maintainer may initiate one or more remotely performable maintenance actions, for example remotely performable maintenance actions embodied in or otherwise associated with the at least one remotely performable maintenance suggestion associated with the at least one notification. In this regard, the user device associated with the user may receive the notification and output the notification via a display of the user device to enable a user to view and/or interact with the notification and/or data therein (e.g., remotely performable maintenance suggestions represented by the data of the notification). The notification may include instructions or other steps for performing remotely performable maintenance actions corresponding to the at least one remotely performable maintenance suggestion.

According to some examples, the method includes outputting at least one additional notification associated with the non-remotely performable maintenance suggestion at optional operation 812. As similarly described with respect to operation 810, in some embodiments, the at least one notification embodies an email notification, text notification, user interface, push notification, or the like renderable via an external computing device. For example, in some embodiments, the apparatus 200 outputs the at least one notification to a particular user device associated with another particular user. In some embodiments for example, the user device is predetermined, determined based at least in part on an asset corresponding to a triggered alert generation rule or generated asset alert, and/or otherwise identifiable by the apparatus 200. In some embodiments, the user device to which the at least one notification is output is associated with a particular user embodying an on-site maintainer associated with one or more asset (e.g., having physical access to the asset). For example, in some embodiments, the maintainer is responsible for performing one or more interactions with the asset and/or subcomponents of the asset to physically alter one or more operational parameters of the asset, replace or repair one or more subcomponents of the asset, and/or otherwise physically interact with the asset in the real-world to maintain the asset. In this regard, the user device associated with the user may receive the notification and output the notification via a display of the user device to enable a user to view and/or interact with the notification and/or data therein (e.g., the non-remotely performable maintenance suggestions represented by the data of the notification).

According to some examples, the method includes automatically initiate a remotely performable maintenance action associated with the remotely performable maintenance suggestion at optional operation 814. For example, in some embodiments, the apparatus 200 is specially configured to access one or more operational aspects of the asset. For example, in some embodiments, the apparatus 200 is communicable with at least the asset over a communications network. In some embodiments where the apparatus 200 determines a remotely performable maintenance suggestion, the apparatus 200 initiates one or more commend(s) transmitted to the asset that causes the asset to initiate at least one remotely performable maintenance action represented by the at least one remotely performable maintenance suggestion. For example, non-limiting examples of remotely performable maintenance suggestions that may be automatically initiated include altering a configuration of an operational parameter of the asset, installing software to the asset, deleting software from the asset, restarting the asset, and/or the like. In some embodiments, the automatic initiation of the remotely performable maintenance action is supervised by a human user, for example via a corresponding client device communicable with the apparatus 200. In some other embodiments, the remotely performable action is initiated manually, such as by a technician user via a corresponding client device.

According to some examples, the method includes receiving user review data based associated with at least one maintenance suggestion at optional operation 816. In some embodiments, the user review data is received from a reviewer device in response to user engagement inputted by a reviewer, for example where the reviewer embodies a subject matter expert or other administrator user associated with the asset and/or the apparatus 200. In some embodiments, the user review data indicates whether the at least one remotely performable maintenance suggestion was properly classified. Additionally or alternatively, in some embodiments, the user review data indicates whether the at least one non-remotely performable maintenance suggestion was properly classified. In some embodiments, the apparatus 200 transmits at least the at least one remotely performable maintenance suggestion, and/or in some embodiments the non-remotely performable maintenance suggestion, to cause the reviewer device to render a user interface enabling a user of the reviewer device to input the user review data.

According to some examples, the method includes updating the intelligence machine learning model based at least in part on the user review data at optional operation 818. For example, in some embodiments, the apparatus 200 causes the intelligence machine learning model to update one or more weighting associated with at least one of the at least one service case recommendation. In some such embodiments, the weighting is updated to increase in a circumstance where the user review data indicates that the maintenance suggestion is accurately classified, or decreased in a circumstance where the user review data indicates that the maintenance suggestion is not accurately classified. In this regard, in some embodiments the intelligence machine learning model is updated to alter the weightings in a direction consistent with a determination of whether the maintenance suggestion is remotely performable based on whether the user review data indicates that the maintenance suggestion is remotely performable or is not remotely performable. In some other embodiments, the intelligence machine learning model is re-trained to update based at least in part on the user review data.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving at least one service case recommendation associated with an asset;
applying the at least one service case recommendation to an intelligence machine learning model,
wherein the intelligence machine learning model is configured to determine a data value indicating a likelihood that each service case recommendation of the at least one service case recommendation is remotely performable;
determining, via the data value output via the intelligence machine learning model for the at least one service case recommendation, at least one remotely performable maintenance suggestion from the at least one service case recommendation; and
outputting at least one notification associated with the at least one remotely performable maintenance suggestion to a user associated with remote access of the asset.

2. The computer-implemented method of claim 1, further comprising:
determining, via the data value output via the intelligence machine learning model for the at least one service case recommendation, at least one non-remotely performable maintenance suggestion; and
outputting at least one additional notification associated with the non-remotely performable maintenance suggestion to the user.

3. The computer-implemented method of claim 1, further comprising:
outputting at least one additional notification associated with a non-remotely performable maintenance suggestion to a second user associated with performing a non-remotely performable maintenance action of the asset.

4. The computer-implemented method of claim 1, wherein the at least one service case recommendation is determined based at least in part on an alert generation rule for the asset.

5. The computer-implemented method of claim 1, further comprising:
automatically initiating a remotely performable maintenance action associated with the remotely performable maintenance suggestion.

6. The computer-implemented method of claim 1, further comprising:
updating the intelligence machine learning model based at least in part on user review data indicating whether a particular service case recommendation of the at least one service case recommendation is accurately characterized as remotely performable or not remotely performable.

7. The computer-implemented method of claim 1, wherein the intelligence machine learning model determines an initial data value indicating the likelihood that a service case recommendation is remotely performable based at least in part natural language processing of the service case recommendation.

8. The computer-implemented method of claim 1, further comprising:
determining at least a first service case recommendation of the at least one service case recommendation is always remotely performable.

9. The computer-implemented method of claim 8, wherein determining at least the first service case recommendation of the at least one service case recommendation is always remotely performable comprising:
processing text data associated with the at least the first service case recommendation utilizing at least one natural language processing model.

10. The computer-implemented method of claim 1, further comprising:
determining at least a first service case recommendation of the at least one service case recommendation is always not remotely performable.

11. The computer-implemented method of claim 10, wherein determining at least the first service case recommendation of the at least one service case recommendation is not always performable comprises:
processing text data associated with the first service case recommendation utilizing at least one natural language processing model.

12. The computer-implemented method of claim 1, further comprising:
applying user configuration data to the intelligence machine learning model,
wherein the intelligence machine learning model is configured to determine the data value indicating the likelihood that each service case recommendation of the at least one service case recommendation is remotely performable based at least in part on the user configuration data.

13. An apparatus comprising:
at least one processor; and
at least one memory storing computer-coded instructions that, when executed by the at least one processor, cause the apparatus to:
receive at least one service case recommendation associated with an asset;
apply the at least one service case recommendation to an intelligence machine learning model,
wherein the intelligence machine learning model is configured to determine a data value indicating a likelihood that each service case recommendation of the at least one service case recommendation is remotely performable;
determine, via the data value output via the intelligence machine learning model for the at least one service case recommendation, at least one remotely performable maintenance suggestion from the at least one service case recommendation; and
output at least one notification associated with the at least one remotely performable maintenance suggestion to a user associated with remote access of the asset.

14. The apparatus of claim 13, wherein the instructions further cause the apparatus to:
determine, via the data value output via the intelligence machine learning model for the at least one service case recommendation, at least one non-remotely performable maintenance suggestion; and
output at least one additional notification associated with the non-remotely performable maintenance suggestion to the user.

15. The apparatus of claim 13, wherein the instructions further cause the apparatus to:
output at least one additional notification associated with a non-remotely performable maintenance suggestion to a second user associated with performing a non-remotely performable maintenance action of the asset.

16. The apparatus of claim 13, wherein the instructions further cause the apparatus to:
automatically initiate a remotely performable maintenance action associated with the remotely performable maintenance suggestion.

17. The apparatus of claim 13, wherein the instructions further cause the apparatus to:
update the intelligence machine learning model based at least in part on user review data indicating whether a particular service case recommendation of the at least one service case recommendation is accurately characterized as remotely performable or not remotely performable.

18. The apparatus of claim 13, wherein the instructions further cause the apparatus to:
determine at least a first service case recommendation of the at least one service case recommendation is always remotely performable.

19. The apparatus of claim 13, wherein the instructions further cause the apparatus to:
apply user configuration data to the intelligence machine learning model,
wherein the intelligence machine learning model is configured to determine the data value indicating the likelihood that each service case recommendation of the at least one service case recommendation is remotely performable based at least in part on the user configuration data.

20. A computer program product comprising at least one non-transitory computer-readable storage medium, the at least one non-transitory computer-readable storage medium including computer program code that when executed by at least one processor, configures the at least one processor to:
receive at least one service case recommendation associated with an asset;
apply the at least one service case recommendation to an intelligence machine learning model,
wherein the intelligence machine learning model is configured to determine a data value indicating a likelihood that each service case recommendation of the at least one service case recommendation is remotely performable;
determine, via the data value output via the intelligence machine learning model for the at least one service case recommendation, at least one remotely performable maintenance suggestion from the at least one service case recommendation; and
output at least one notification associated with the at least one remotely performable maintenance suggestion to a user associated with remote access of the asset.
